(19) United States
(12) Patent Application Publication
(10) Pub. No.: US 2008/0166684 A1
(43) Pub. Date: Jul. 10, 2008

(54) DENTAL SUCTION APPLIANCE

(76) Inventor: David C. Kanas, Gold River, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/621,449

(22) Filed: Jan. 9, 2007

(51) Int. Cl. A61C 17/06

(52) U.S. Cl. 433/93

(57) ABSTRACT

Apparatus and methods for providing a dental appliance that functions as an aspirator and tongue deflector. The aspirator has a proximal end and a distal end configured to be positioned at near a treatment location in the mouth of the patient. A tongue deflector is disposed on the distal end of the aspirator for controlling movement of the patient's tongue at the location. An elongate aspiration tube emanates at the proximal end of the aspirator and terminates at the tongue deflector for aspirating liquids at or near the treatment location. The aspirator tube has an aspiration channel running concentrically along the aspiration tube from the proximal end to a collection recess in the tongue deflector. The dental appliance may be fabricated such that the tongue deflector and aspirator are formed as one contiguous unitary piece.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to dental appliances, and more particularly to an apparatus for deflecting the tongue, aspirating liquids, and maintaining the patient's mouth in an open position during oral surgery and other dental procedures.

2. Description of Related Art

A common problem for dentists and dental hygienists performing surgery and other dental procedures is the removal of saliva generated by the patient, removal of water used to cool high speed drills, and removal of water and other liquids used in connection with certain procedures. During most of these procedures, the dentist, dental assistant, or hygienist must manually place a suction tube in the patient's mouth for aspiration of liquids. And, in order to achieve proper and efficient aspiration, it is often necessary to hold the suction tube in place or to move it around in a vacuuming motion.

In addition, it is often necessary for the dentist or dental assistant to deflect the patient's tongue away from the area in which work is being performed. And, during the time that the procedure is being performed, the patient undergoes stress in an effort to keep his or her mouth in an open position.

As a result, the work space inside the mouth is reduced or otherwise encumbered by the various dental appliances being used by the dentist and the dental assistant. In addition, the patient's jaw muscles become tense and it be difficult for the patient to maintain the mouth in an open position.

Various devices have been developed to assist the dentist while performing dental procedures. For example, U.S. Pat. No. 4,975,057 issued to Dyfvermark on Dec. 4, 1990, discloses a bite block having an aperture for insertion of a suction nozzle associated with an aspiration device. However, this particular device is not suited for use by patients who are missing teeth and cannot effectively clamp the bite block in place and, furthermore, does not provide for deflecting the tongue away from the work area. U.S. Pat. No. 4,024,642 issued to Zorovich on May 24, 1977, discloses a bite block coupled to an hour-glass shaped shield having a system of suction channels. This device, however, does not deflect the tongue, greatly restricts the dentist's work area, and requires external control of the level of suction. U.S. Pat. No. 3,924,333 issued to Erickson on Dec. 9, 1975, discloses a bite block with left and right tongue guards and a series of channels which communicate with an evacuation tube. This device, however, cannot be held in place where a patient has several missing teeth, cannot be easily installed and removed in the mouth, and is difficult to use. U.S. Pat. No. 3,090,122 issued to Erickson on May 21, 1963, discloses a receptacle for placement in one side of the mouth, and has apertures and drains for aspirating fluids. This device, however, is best suited for a reclining patient and severely limits the dentist's work space.

Thus described have been devices which are independent of the handpiece used by the dentist. However, various tongue deflectors and shields can be found as attachments for a handpiece. For example, U.S. Pat. No. 1,004,118 issued to Waters on Sep. 26, 1911, discloses a handpiece mounted shield having slotted receptacles to allow the position of the shield to be changed for working on either side of the mouth. U.S. Pat. No. 1,067,571 issued to Abbott on Jul. 15, 1913, discloses a handpiece mounted shield which can be rotated from side to side. U.S. Pat. No. 2,671,269 issued to Francis on Mar. 9, 1954, discloses a tongue deflector for mounting to the head of a dental handpiece. U.S. Pat. No. 2,731,722 issued Wilen on Jan. 24, 1956, discloses a spoon-shaped tongue deflector and shield for attachment to a dental handpiece which has a tube for carrying a water spray. U.S. Pat. No. 2,924,013 issued to Wowra on Feb. 9, 1990; U.S. Pat. No. 1,516,933 issued to Terranova on Nov. 25, 1924; U.S. Pat. No. 1,152,122 issued to Samphere on Aug. 31, 1915; and U.S. Pat. No. 594,952 issued to Hoyer on Dec. 7, 1987, all disclose variously styled tongue and cheek shields for attachment to a dental handpiece.

In addition to the deficiencies previously described, none of these devices provides a viable solution to deflecting the tongue, aspirating liquids, and maintaining the mouth in an open position while, at the same time, maximizing the unencumbered work area for the dentist. Ideally, a single, uniform dental appliance would provide for deflecting the tongue, aspirating liquids with variable suction level, and maintaining the patient's mouth in an open position. None of the devices heretofore developed, however, meets the existing need for such a device. The present invention satisfies that need.

### BRIEF SUMMARY OF THE INVENTION

An aspect of the invention is an apparatus for performing dental work on a patient. The apparatus comprises an aspirator having a proximal end and a distal end configured to be positioned at near a treatment location in the mouth of the patient. A tongue deflector is disposed on the distal end of the aspirator for controlling movement of the patient's tongue at said location. An elongate aspiration tube emanates at the proximal end of the aspirator and terminates at the tongue deflector for aspirating liquids at or near the treatment location. The aspirator tube has an aspiration channel running concentrically along the aspiration tube from the proximal end to the tongue deflector. The aspirator consists of a single, contiguous material such that the tongue deflector and aspiration tube form a unitary member.

Generally, the aspirator comprises a rigid material (e.g. a hard thermoplastic) such that the tongue deflector is restricted from motion with respect to the aspiration tube. However, other materials known in the art may also be used.

In one embodiment, the tongue deflector comprises a first (e.g. upper) surface having a recess, wherein the recess has a floor configured to facilitate collection of fluids at the location. The floor of the recess has a vacuum opening in communication with the aspiration channel to allow fluids to be directed from the recess of the tongue deflector, through the aspiration channel, to exit out the proximal end of the aspirator.

In a preferred embodiment, the vacuum opening is disposed below the first surface to minimize contact of soft tissue with the vacuum opening. The vacuum opening is disposed normal to the aspiration channel such that fluids are drawn downward into the channel from the recess.

In another embodiment, a bite tube is releasably and slideably attached to the aspirator. The bite tube is configured to support and stabilize aspirator in the patient's mouth, and to be positioned a varying points along the aspiration tube. The bite tube may comprise an open first end and an open second end, said first and second ends forming first and second tooth receptacles, whereby said bite tube is secured in the mouth by placing a tooth in at least one of said tooth receptacles and biting down on the bite tube.

In one mode, at least a portion of the bite tube comprises a compliant material, e.g. Styrofoam or the like.

In another embodiment, the tongue deflector comprises a second surface opposite the first surface, wherein the second surface has a tooling hole used to fabricate the aspirator as a unitary plastic injection mold.

Another aspect is a method of fabricating a dental appliance for deflecting the tongue and aspirating liquids in the mouth of a patient undergoing dental work. The method includes the steps of disposing a core pin inside a mold cavity shaped to form an aspirator from a unitary piece of plastic, wherein the aspirator comprises a tongue deflector on its distal end and an aspirator tube on its proximal end, and an aspiration channel spanning along the aspirator tube from the proximal end to a location at the tongue deflector. The aspiration channel is formed by the core pin. The method further includes the steps of supporting the core pin inside the mold cavity with a support pin, and injecting plastic in the mold cavity to form the unitary aspirator around the core pin. Generally, the support pin creates a tooling hole in the aspirator.

In one embodiment, the tooling hole is located within the tongue deflector. In another embodiment, the mold is configured to create a recess in the tongue deflector, wherein the recess is in fluid communication with the aspiration channel.

Another aspect is a dental apparatus comprising an aspirator having an aspiration tube portion at its proximal end and a tongue deflector portion at its distal end, wherein tongue deflector portion is configured to be positioned at near a treatment location in a patient's mouth and extends laterally from an axis of the aspiration tube portion to control movement of the patient's tongue at the location. The aspiration tube section comprises an aspiration channel extending from the proximal end to the tongue deflector for aspirating liquids at or near the treatment location. The tongue deflector portion and the aspirator tube portion are formed from a single, contiguous, unitary member.

In a preferred embodiment, the tongue deflector portion comprises a first surface having a recess with a floor configured to facilitate collection of fluids at the location. The floor has a vacuum opening in communication with the aspiration channel to allow fluids to be directed from the recess of the tongue deflector and through the aspiration channel to the proximal end of the aspirator.

A bite tube may also be used, wherein the bite tube is configured to releasably and slideably attach to the aspirator tube portion; wherein the bite tube is configured to support and stabilize aspirator in the patient's mouth.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 illustrates a perspective view of the aspiration device of the present invention.

FIG. 2 is a top view of the aspiration device of FIG. 1.

FIG. 3 is a bottom view of the aspiration device of FIG. 1 with the bite tube removed.

FIG. 4 is a perspective view of the distal end of the aspiration device of FIG. 1.

FIG. 5 shows a side view of the bite tube of the present invention removed from the aspiration device.

FIG. 6 shows a front view of the bite tube of FIG. 5

FIG. 7 illustrates a side view of the aspiration device of FIG. 1.

FIG. 8 illustrates an exemplary manufacturing setup for the aspiration device of the present invention.

### DETAILED DESCRIPTION OF THE INVENTION

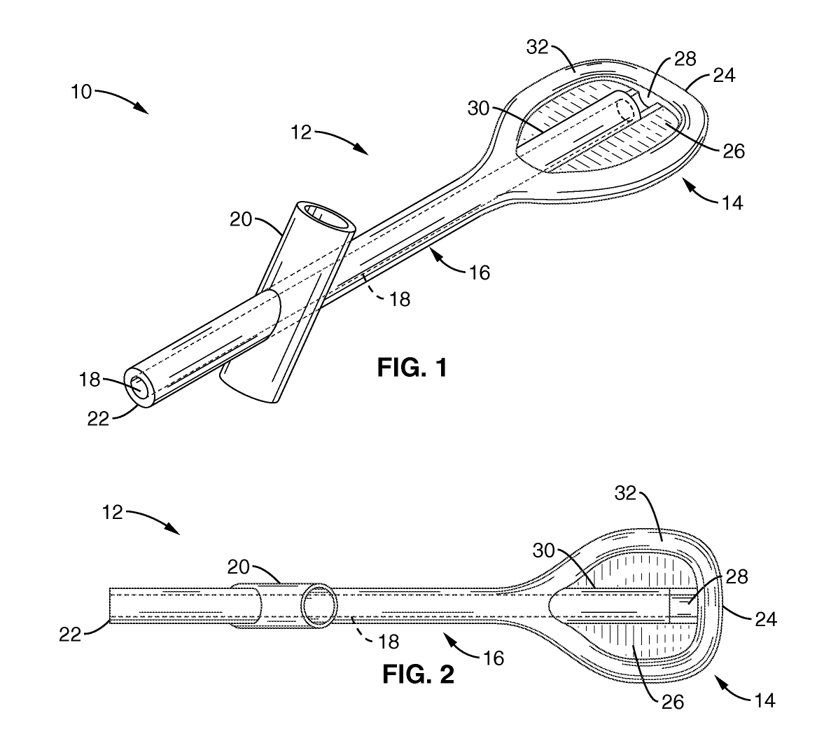

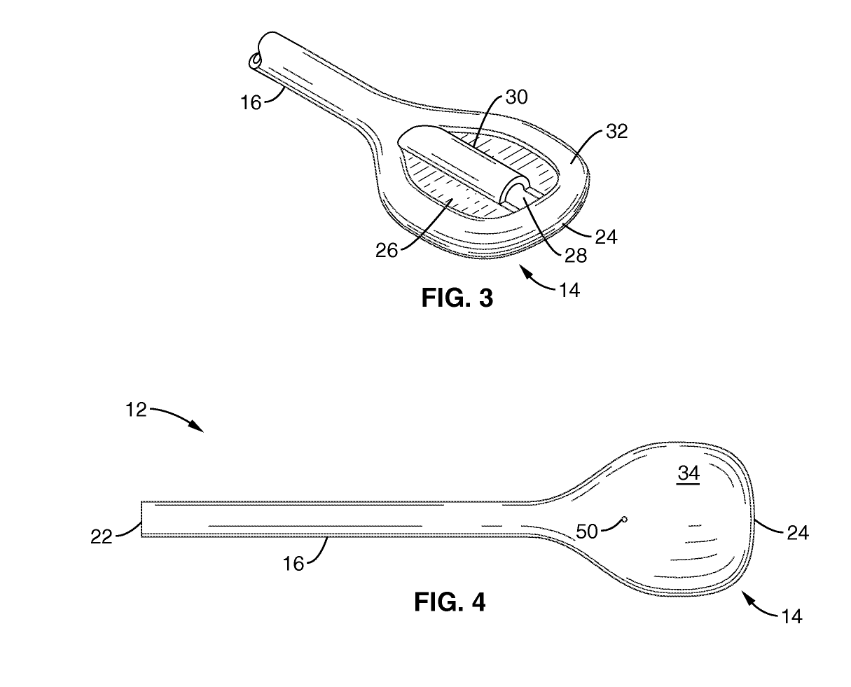

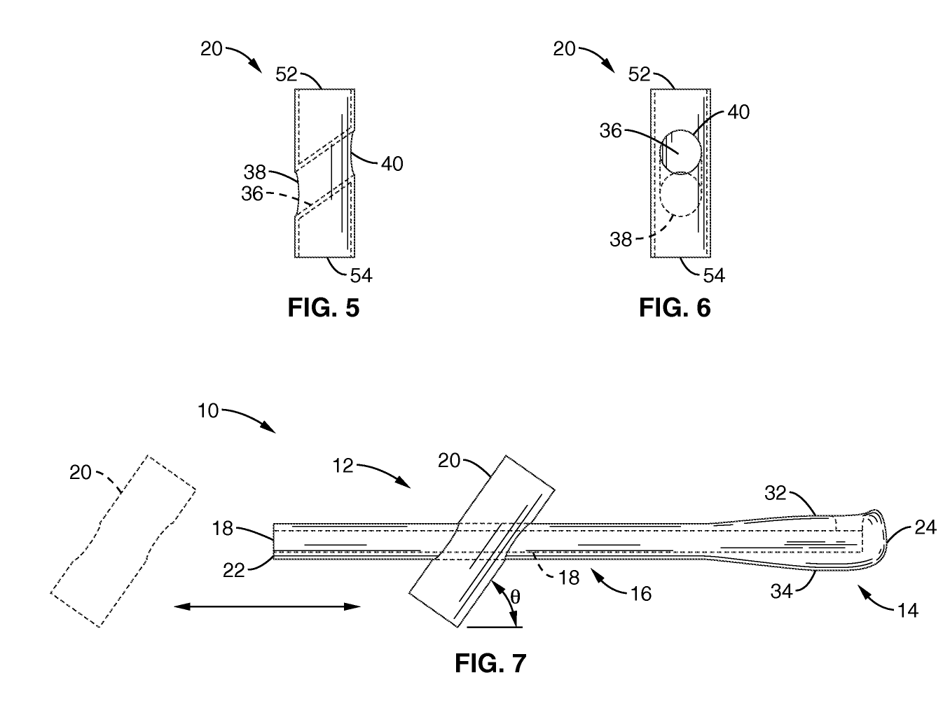

Referring more specifically to the drawings, for illustrative purposes the present invention is embodied in the apparatus generally shown in FIG. 1 through FIG. 8. It will be appreciated that the apparatus may vary as to configuration and as to details of the parts, and that the method may vary as to the specific steps and sequence, without departing from the basic concepts as disclosed herein.

Referring to FIG. 1 through FIG. 3, the dental appliance 10 in accordance with the present invention includes an aspirator 12 having a tongue deflector 14 at its distal end 24. The aspirator 12 tapers inward from the distal end 24 to form a generally cylindrical aspiration tube 16 that terminates at a proximal end 22.

The tongue deflector 14 and aspirator tube 16 form a unitary, contiguous member (aspirator 12) that is preferably constructed from the same material. Preferably, the aspirator 12 is fabricated from plastic or the like material that can be plastic injection molded as a unitary piece (described in further detail below). Preferably, aspirator 12 is either disposable or suitable for sterilization after use.

The aspirator is generally sized to accommodate the anatomical features of the patient's mouth. Thus, dimensions may be varied to fit smaller or larger patients, or be sized to fit all patients. While, other dimensions can be used, it is generally preferred that tongue deflector 14 portion be approximately one inch (2.54 cm) wide or less, and approximately one inch (2.54 cm) in length. The aspirator tube 16 is sized to have a profile smaller than the tongue deflector 14, e.g. having a diameter of approximately 0.25 inches.

A tubular channel 18 extends generally concentric along the aspirator tube 16, emanating at the proximal end 22 and terminating at opening 30, which is located prior to the distal extreme 24 of the tongue deflector 14. The outer diameter of the aspirator tube 16 is generally slightly larger than the diameter of channel 18.

Aspirator tube 16 extends beyond the proximal end of tongue deflector 14 in an elongate fashion to allow the proximal end 22 to extend out the patients mouth and accessible for coupling to a vacuum pump, e.g. by using a flexible hose or the like. By positioning the distal end 28 of aspiration tube 24 such that it is spaced apart from wall 20 in tongue deflector 12, a vacuum gap 30 is formed through which liquids and small particles can be aspirated.

The buccal (i.e. upper) surface 32 of tongue deflector 14 has a recess 26 forming a bowl or cup-like shape. Toward the distal end of the recess, and in between end 30 of the aspirator tube 16, the floor of recess 26 is further recessed to form a vacuum opening 28. Vacuum opening 28 allows vertical communication to the aspirator channel 18 from the recess 26. The recess 26 allows fluids in the mouth to collect and be directed toward vacuum opening 28 and removed through channel 18 and out proximal end 22. In addition, amalgam shavings can be placed directly into vacuum opening 28 and removed, thus decreasing any amounts of mercury that would otherwise be deposited in the mouth.

The size of the vacuum opening 28 is sized to provide the proper amount of suction (i.e. strong enough suction to pull in fluids and other debris, and yet weak enough so not to pull in tissue from the patient's mouth). Generally, the dimensions of the opening 28 are sized to correspond to the vacuum pressure provided by most vacuum pumps used in the art. For example, the vacuum opening of the device shown in FIG. 1 is generally rectangular, having sides of approximately 0.17″×0.17″. It is appreciated that the dimensions of the opening 28 may vary depending on the diameter of the aspirator tube channel 18 or vacuum pump. An exemplary range of side dimensions of the opening 28 may be from 0.12″ to 0.23.″ It is also appreciated that the opening 28 may comprise a non-rectangular shape, e.g. a circular shape.

The device 10 of the present invention also acts as a defogging device, pulling moisture vapor out of the treatment region (e.g. where a mirror may be placed) of the patient's mouth and into to vacuum opening 28. Thus, physician time is saved by use of the device because fogging of mirrors or like instruments is minimized or removed.

The pre-set opening size of the vacuum opening 28 provides a number of advantages over existing devices. In the configuration shown in FIGS. 1-3, the vacuum pressure during operation is constant (unless varied externally by vacuum pump or other instrument), and can't be accidentally shut off or varied from any manipulation of the aspirator 12 in the treatment region of the patient's mouth. In addition, the one piece structure of the aspirator 12 (e.g. integral, contiguous aspirator tube 16 and tongue deflector 14) provides a more rigid interface, preventing motion of the aspirator tube 16 with respect to the tongue deflector 14. In addition, the one-piece construction allows for a larger diameter aspiration channel 18, without increasing the dimensions of the tongue deflector 14.

The recess 26 in buccal surface 32 also serves as a spacer to position vacuum opening 28 away from soft tissue in the mouth against which the buccal surface 32 and vacuum opening 28 would otherwise rest. This prevents soft tissue from being drawn into vacuum opening 28 and stopping the suction. This is particularly advantageous when used on periodontal patients who have surgery and have exposed cementum on the root surface. The exposed cementum is an area which is highly sensitive to vacuum or air and, therefore, it is important to be able to minimize suction. Even at times when very soft sublingual tissue might be drawn into vacuum opening 28, due to the low vacuum level employed, no damage will result to the soft tissue that is drawn into opening 28.

As shown in FIG. 7 the lingual (i.e. lower) surface 34 of tongue deflector 14 portion is generally flat, or slight convex curvature. The geometry of the lingual surface 34 gently holds the tongue away from the teeth and toward the mid area of the mouth, thereby limiting movement of the tongue and providing sufficient room for the dentist or hygienist to perform the required dental procedure.

Referring to FIGS. 1, 2, 5 and 6, aspiration tube 24 is coupled to a bite tube 20, which is configured to support and stabilize aspirator 12 in the patient's mouth. In a preferred embodiment, bite tube 20 is an elongate tubular member having an upper tooth receptacle 52 and a lower tooth receptacle 54. It is appreciated, however, that bite tube 20 may comprise a number of shapes including cylindrical-shaped, triangular-shaped, and rectangular or like shapes. It will also be appreciated that bite tube 20 could be hollow or, alternatively, it could be a solid member with hollowed ends to form upper tooth receptacle 52 and lower tooth receptacle 54.

In one embodiment, bite tube 20 is fabricated from a lightweight rigid material such as plastic or the like. Alternatively, all or a portion (e.g. upper and lower ends) of the bite tube 20 may comprise a deformable material (e.g. Styrofoam, or the like) that allows the patient to sink their teeth into the bite tube20.

The bite tube 20 is configured to be detachably received on the aspirator 12. Bite tube 20 has a bore 36 that runs through the side of the bite tube 20 to form an anterior opening 38 and posterior opening 40. This allows the proximal end 18 of the aspirator 12 to be extended through anterior opening 38 and posterior opening 40 for support.

Referring now to FIG. 7, anterior opening 38 and posterior opening 40 are preferably displaced by an angle θ, so that aspiration tube 20 slants downward relative to a horizontal position. As shown in FIG. 7, angle θ is shown to be approximately 60 degrees. While an angle of 60 degrees is generally preferred, any angle (e.g. within a range of approximately 45 degrees through 90 degrees) could be employed.

The bite tube 20 is secured in the patient's mouth by having the patient gently bite down to insert opposing (one upper and one lower) teeth in upper receptacle 52 and lower receptacle 54, respectively. Alternatively, one tooth (either upper or lower) could be engaged in a receptacle and the other end of the bite tube supported by a cotton roll or the like between the bite tube and the gum tissue where an opposing tooth is missing. Note that the use of bite tube 20 is distinctly advantageous in that conventional bite blocks must be secured in place with several upper and lower teeth. The present invention, however, can be secured in place even though a patient is missing teeth.

In one embodiment, a portion of a cotton roll or the like may be positioned to be retained in the upper and lower receptacles 52, 54, thus providing extra stability and grip.

In general, bite tube 20 is secured on the side of the mouth opposite from the side of the mouth on which the dental procedure will be performed so that the tongue is retracted away from the work area. Referring also to FIG. 7, it can be seen that different sizes of the mouth, as well as work area positions, can be accommodated by sliding aspiration tube 16 back and forth in bite tube 20 until tongue deflector 14 is in the desired position. For example, the device may be fit to an adult, or person with a wide arch, by sliding the bite tube 20 toward the proximal end 22 of the aspirator tube 16. Accordingly, the bite may be fit to a child, or person with a narrow arch, by sliding the bite tube 20 toward the distal end 24 or tongue deflector portion 14.

Generally, the bore 36 has a diameter that is equal or slightly less than the outside diameter of the aspirator tube 16 so that a snug fit secures the bite tube 20 on the aspirator 12, while allowing the aspirator tube 16 to rotate or translate within bore 36 with slight manual pressure.

It should also be noted that aspirator 12 can be rotated 360 degrees about bite tube 20 so that the position of the tongue deflector portion 14 can be adjusted in the mouth while maintaining a constant suction level. This feature also permits the device to be used on either side of the mouth with ease.

According to one embodiment of the invention, it is contemplated to use the aspirator 12 without the bite tube 20. Referring to FIG. 7, there may be occasions where it is desirable to dispense with the bite tube 20 (e.g. sliding it off of the proximal end 22 of aspirator 12 (shown in phantom)) and to use a conventional dental handpiece or other dental instrument for support. In one embodiment, a standoff bracket or the like piece (such as that shown in U.S. Pat. No. 5,232,362, herein incorporated by reference in its entirety) could be used to couple aspirator 12 to the handpiece. In this configuration, the dentist or hygienist can reposition the tongue deflector 14 portion (and vacuum gap 30) as the handpiece is moved.

Referring back to FIG. 4, the aspirator 12 also comprises a tooling hole, 50 located at the lingual surface 34 of the tongue deflector 14. The tooling hole 50 allows the aspirator 12 to be manufactured as a one-piece construction. Although it is contemplated that the aspirator tube section 16 and tongue deflector 14 could be manufactured as separate pieces (i.e. extrusion) and then fused or bonded, it is much more preferable (from both a manufacturing cost standpoint, and from a functional standpoint as described above) to have the aspirator injection-molded as one piece.

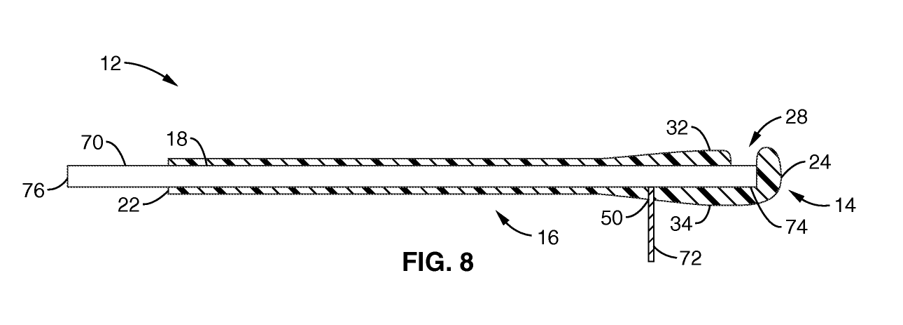

FIG. 8 illustrates an exemplary method for manufacturing the aspirator 12 of the present invention. As shown in FIG. 8, the aspirator 12 may be fabricated as a unitary plastic structure by plastic mold injection. To facilitate fabrication, a center core pin 70 is positioned in the mold cavity to construct the aspiration channel 18 of the aspirator 12. To support the distal end 74 in its proper concentric position along aspirator tube 16, a support pin 72 runs generally normal from the bottom surface 34 of the tongue deflector portion 14 (defined by the lower wall of the mold (not shown)). The support pin 72 accordingly creates tooling hole 50 that runs from bottom surface 34 into the aspiration chamber 18. To minimize effect of the tooling hole 50 with the suction properties of the aspirator 12, the support pin 72 can be sized to have a small diameter, e.g. 0.050 inches or less. Tooling hole 50 allows fabrication of a unitary aspirator structure 12 having a tongue deflector portion 14 and a aspirator tube portion 16.

Accordingly, it will be seen that the present invention provides for stabilization of the patient's mouth in an open position as well as deflecting the tongue while removing liquid which would otherwise accumulate in the mouth. Therefore, difficult dental procedures can be performed with minimal discomfort to the patient and with less distraction to the dentist which would otherwise occur where multiple dental appliances are required to serve the same function. For example, lower molar crown preparations or fillings on the opposite side of the mouth generally require retraction of the tongue by the dentist and use of a mouth mirror while trying to work on the lingual side of the tooth and trying to keep the area from filling up with saliva and debris. The present invention will serve to retract the tongue and keep the work area free of liquid at the same time, as well as to reduce back strain to the dentist or hygienist who would otherwise be using several dental appliances to accomplish the same task as the present invention. As a result, the dentist and hygienist can work more efficiently, thereby reducing the cost of the procedure. At the same time, the patient is made more comfortable while undergoing treatment.

The aspirator of the present invention is uniquely configured so that the elongate aspirator tube and tongue deflector can be fabricated as a unitary piece through a single manufacturing step, thus decreasing manufacturing costs, and improving the functionality of the device.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for performing dental work on a patient, comprising:
an aspirator having a proximal end and a distal end;
wherein the distal end of the aspirator is configured to be positioned at near a treatment location in the mouth of the patient;
the aspirator comprising:
a tongue deflector for controlling movement of the patient's tongue at said location;
the tongue deflector disposed on the distal end of the aspirator;
an elongate aspiration tube for aspirating liquids at or near the treatment location;
the aspiration tube emanating at the proximal end of the aspirator and terminating at the tongue deflector; and
an aspiration channel running concentrically along the aspiration tube from the proximal end to the tongue deflector;
wherein the aspirator is a single, contiguous material such that the tongue deflector and aspiration tube form a unitary member.

2. An apparatus as recited in claim 1, wherein the aspirator comprises a rigid material such that the tongue deflector is restricted from motion with respect to the aspiration tube.

3. An apparatus as recited in claim 1:
wherein the tongue deflector comprises a first surface having a recess;
the recess having a floor configured to facilitate collection of fluids at the location;
the floor comprising a vacuum opening in communication with the aspiration channel to allow fluids to be directed from the recess of the tongue deflector and through the aspiration channel to the proximal end of the aspirator.

4. An apparatus as recited in claim 3, wherein the vacuum opening is disposed below the first surface to minimize contact of soft tissue with the vacuum opening.

5. An apparatus as recited in claim 3, wherein the vacuum opening is disposed normal to the aspiration channel such that fluids are drawn downward into the channel from the recess.

6. An apparatus as recited in claim 1, further comprising:
a bite tube releasably and slideably attached to the aspirator; wherein the bite tube is configured to support and stabilize the aspirator in the patient's mouth.

7. An apparatus as recited in claim 6, wherein the bite tube is configured to be positioned a varying points along the aspiration tube to accommodate differing patient anatomies.

8. An apparatus as recited in claim 7:
wherein the bite tube comprises an open first end and an open second end;
said first and second ends forming first and second tooth receptacles;
whereby said bite tube is secured in the mouth by placing a tooth in at least one of said tooth receptacles and biting down on the bite tube.

9. An apparatus as recited in claim 6, wherein at least a portion of the bite tube comprises a compliant material.

10. An apparatus as recited in claim 9, wherein at least a portion of the bite tube comprises Styrofoam.

11. An apparatus as recited in claim 3:
wherein the tongue deflector comprises a second surface opposite said first surface;
said second surface comprising a tooling hole used to fabricate the aspirator as a unitary plastic injection mold.

12. A method of fabricating a dental appliance for deflecting the tongue and aspirating liquids in the mouth of a patient undergoing dental work, comprising:
disposing a core pin inside a mold cavity;
wherein the mold cavity is shaped to form an aspirator from a unitary piece of plastic;
the aspirator comprising a tongue deflector on its distal end and an aspirator tube on its proximal end;
the aspirator further comprising an aspiration channel spanning along the aspirator tube from the proximal end to a location at the tongue deflector;
wherein the aspiration channel is formed by the core pin;
supporting the core pin inside the mold cavity with a support pin; and
injecting plastic in the mold cavity to form the unitary aspirator around the core pin.

13. A method as recited in claim 12, wherein the support pin creates a tooling hole in the aspirator.

14. A method as recited in claim 13, wherein the tooling hole is located within the tongue deflector.

15. A method as recited in claim 12:
wherein the mold is configured to create a recess in the tongue deflector; and
wherein the recess is in fluid communication with the aspiration channel.

16. A dental apparatus, comprising:
an aspirator having an aspiration tube portion at its proximal end and a tongue deflector portion at its distal end;
wherein tongue deflector portion is configured to be positioned at near a treatment location in a patient's mouth;
wherein the tongue deflector portion extends laterally from an axis of the aspiration tube portion to control movement of the patient's tongue at said location;
wherein the aspiration tube section comprises an aspiration channel extending from the proximal end to the tongue deflector for aspirating liquids at or near the treatment location; and
wherein the tongue deflector portion and the aspirator tube portion are formed from a single, contiguous, unitary member.

17. An apparatus as recited in claim 16:
wherein the tongue deflector portion comprises a first surface having a recess;
the recess having a floor configured to facilitate collection of fluids at the location;
the floor comprising a vacuum opening in communication with the aspiration channel to allow fluids to be directed from the recess of the tongue deflector and through the aspiration channel to the proximal end of the aspirator.

18. An apparatus as recited in claim 17, wherein the vacuum opening is disposed below the first surface to minimize contact of soft tissue with the vacuum opening.

19. An apparatus as recited in claim 18, wherein the vacuum opening is disposed normal to the aspiration channel such that fluids are drawn downward into the channel from the recess.

20. An apparatus as recited in claim 16, further comprising:
a bite tube configured to releasably and slideably attach to the aspirator tube portion; wherein the bite tube is configured to support and stabilize aspirator in the patient's mouth.

21. An apparatus as recited in claim 20, wherein the bite tube is configured to be oriented at various positions on the aspirator tube to accommodate differing patient anatomies.

22. An apparatus as recited in claim 20, wherein at least a portion of the bite tube comprises a compliant material.

23. An apparatus as recited in claim 16:
wherein the tongue deflector portion comprises a second surface opposite said first surface;
said second surface comprising a tooling hole used to fabricate the aspirator as a unitary plastic injection mold.

24. An apparatus as recited in claim 16, wherein the apparatus is configured to defog a region of the patient's mouth.
